(19) United States
(12) Patent Application Publication
(10) Pub. No.: US 2023/0339497 A1
(43) Pub. Date: Oct. 26, 2023

(54) Method, Apparatus, Device and Computer-Readable Medium for Trajectory Compression

(71) Applicant: JINGDONG CITY (BEIJING) DIGITS TECHNOLOGY CO., LTD., Beijing (CN)

(72) Inventors: Zisheng YU, Beijing (CN); Junwen LIU, Beijing (CN); Rubin WANG, Beijing (CN); Yuan SUI, Beijing (CN)

(21) Appl. No.: 18/101,927

(22) Filed: Jan. 26, 2023

(30) Foreign Application Priority Data
Apr. 22, 2022 (CN) 202210429166.X

(51) Int. Cl. B60W 60/00; B60W 40/06

(52) U.S. Cl. CPC B60W 60/001; B60W 40/06; B60W 2556/05; B60W 2556/30

(57) ABSTRACT

The present invention discloses a method, apparatus, device and computer-readable medium for trajectory compression, and relates to the technical field of computers. One specific implementation of the method comprises: screening, among trajectory points of a traveling trajectory, reserved trajectory points of the traveling trajectory according to deviation degrees of the trajectory points from roads; determining, in conjunction with traveling periods of the reserved trajectory points, the reserved trajectory points as key trajectory points, the traveling period being a time interval from a previous trajectory point of the reserved trajectory point to a next trajectory point of the reserved trajectory point; adding the starting point of the traveling trajectory, the key trajectory points and the ending point of the traveling trajectory to a compressed trajectory so as to compress the traveling trajectory. This implementation can reduce the time complexity of compression of trajectory data, and thereby decrease the time consumption for compression.

### TECHNICAL FIELD

The present invention relates to the technical field of computers, in particular a method, apparatus, device and computer-readable medium for trajectory compression.

### BACKGROUND ART

With the popularization of intelligent locators and the arrival ofthe “Big Data” era, a massive amount of trajectory data has been generated, including trajectory data of vehicles, pedestrians and various collection devices. The massive amount of trajectory data which increases continuously requires more storage spaces. However, physical storage resources are precious and limited, which requires us to compress trajectory data, i.e., to minimize the spaces occupied by trajectory data while ensuring data availability.

In the process of implementing the present invention, the inventor discovered that the prior art has at least the following problems: when trajectory data is compressed using a lossy compression method, the time complexity is too high, which gives rise to an increase in the time consumption for compression.

### SUMMARY OF THE INVENTION

For this reason, the embodiments of the present invention provide a method, apparatus, device and computer-readable medium for trajectory compression, capable of reducing the time complexity of compression of trajectory data, and thereby decreasing the time consumption for compression.

To achieve the above object, a method for trajectory compression is provided according to an aspect of the embodiments of the present invention, comprising:
screening, among trajectory points of a traveling trajectory, reserved trajectory points of the traveling trajectory according to deviation degrees of the trajectory points from roads;
determining, in conjunction with traveling periods of the reserved trajectory points, the reserved trajectory points as key trajectory points, the traveling period being a time interval from a previous trajectory point of the reserved trajectory point to a next trajectory point of the reserved trajectory point;
adding the starting point of the traveling trajectory, the key trajectory points and the ending point of the traveling trajectory to a compressed trajectory so as to compress the traveling trajectory.

Screening, among trajectory points of a traveling trajectory, reserved trajectory points of the traveling trajectory according to deviation degrees of the trajectory points from roads includes:
determining, amongtrajectory points of a traveling trajectory, the deviation degree of a current trajectory point based on a previous trajectory point of the current trajectory point and a next trajectory point of the current trajectory point;
taking the current trajectory point which has a deviation degree greater than the deviation threshold as the reserved trajectory point.

Determining the deviation degree of a current trajectory point based on a previous trajectory point of the current trajectory point and a next trajectory point of the current trajectory point includes:
locating the radius of a circle where the current trajectory point is located according to the previous trajectory point, the current trajectory point and the next trajectory point;
determining the deviation degree of the current trajectory point from the radius of the circle where the current trajectory point is located.

Taking the current trajectory point which has a deviation degree greater than the deviation threshold as the reserved trajectory point includes:
setting one or more deviation thresholds according to the roads, and determining a deviation threshold based on a road where the current trajectory point is located;
taking the current trajectory point which has a deviation degree greater than the determined deviation threshold as the reserved trajectory point.

Determining, in conjunction with traveling periods of the reserved trajectory points, the reserved trajectory points as key trajectory points includes:
determining, according to the traveling period of a reserved trajectory point and the radius of a circle where the reserved trajectory point is located, a space-time curvature of the reserved trajectory point, wherein the traveling period of the reserved trajectory point is a time interval from a previous trajectory point of the reserved trajectory point to a next trajectory point of the reserved trajectory point, and the radius of a circle where the reserved trajectory pointis located is determined from the previous trajectory point, the current trajectory point and the next trajectory point;
if the space-time curvatures of the reserved trajectory points are greater than the preset space-time threshold, determining the reserved trajectory points as key trajectory points.

Screening, among trajectory points of a traveling trajectory, reserved trajectory points of the traveling trajectory according to deviation degrees of the trajectory points from roads includes:
screening, among trajectory points of a traveling trajectory, a trajectory point which has a deviation degree greater than the deviation threshold as a reserved trajectory point, wherein the deviation degree is determined by a traveling period of the trajectory point and the radius of a circle where the trajectory point is located;
determining, in conjunction with traveling periods of the reserved trajectory points, the reserved trajectory points as key trajectory points, including:
   taking reserved trajectory points which have ratios greater than the key threshold as key trajectory points, the ratio being equal to a quotient of dividing the traveling period of a reserved trajectory point by the radius of a circle where the reserved trajectory point is located.

The deviation threshold and the key threshold are determined by the number of trajectory points in the compressed trajectory and the number of trajectory points in the traveling trajectory.

According to a second aspect of the embodiments of the present invention, an apparatus for trajectory compression is provided, comprising:
a screening module for screening, among trajectory points of a traveling trajectory, reserved trajectory points of the traveling trajectory according to deviation degrees of the trajectory points from roads;
a determination module for determining, in conjunction with traveling periods of the reserved trajectory points, the reserved trajectory points as key trajectory points, the traveling period being a time interval from a previous trajectory point of the reserved trajectory point to a next trajectory point of the reserved trajectory point;
a compression module for adding the starting point of the traveling trajectory, the key trajectory points and the ending point of the traveling trajectory to a compressed trajectory so as to compress the traveling trajectory.

According to a third aspect of the embodiments of the present invention, an electronic device for trajectory compression is provided, comprising:
one or more processors;
a storage device for storing one or more programs which, when executed by the one or more programs, cause the one or more processors to implement the above method.

According to a fourth aspect ofthe embodiments ofthe invention, there is provided a computer-readable medium storing computer programs thereon which, when executed by a processor, implements the above method.

One embodimentin the aboveinvention has the following advantages or beneficial effects: among trajectory points of a traveling trajectory, reserved trajectory points of the traveling trajectory are screened according to deviation degrees of the trajectory points from roads; in conjunction with traveling periods ofthe reserved trajectory points, the reserved trajectory points are determined as key trajectory points, the traveling period being a time interval from a previous trajectory point of the reserved trajectory point to a next trajectory point of the reserved trajectory point; the starting point of the traveling trajectory, the key trajectory points and the ending point of the traveling trajectory are added to a compressed trajectory so as to compress the traveling trajectory. Since the number of key trajectory points is far smaller than the number of trajectory points, it is possible to reduce the time complexity of compression of trajectory data, and thereby decrease the time consumption for compression.

Further effects achieved by the above non-conventional optional manners will be explained below in conjunction with specific embodiments.

### DESCRIPTION OF ACCOMPANYING DRAWINGS

Accompanying drawings are used for better understandings of the present invention, but do not construe improper limitations of the invention, wherein:

FIG. 1 is a flowchart illustrating the main procedures of the method for trajectory compression according to the embodiments of the present invention;

FIG. 2 is a flowchart of screening reserved trajectory points of a traveling trajectory according to the embodiments of the present invention;

FIG. 3 is a flowchart of determining the deviation degree of a current trajectory points according to the embodiments of the present invention;

FIG. 4 is a schematic diagram illustrating the vehicle traveling according to the embodiments of the present invention;

FIG. 5 is a flowchart of determining reserved trajectory points according to the embodiments of the present invention;

FIG. 6 is a schematic diagram illustrating deviation degrees of a trajectory under a constraint of time according to the embodiments of the present invention;

FIG. 7 is a flowchart of determining key trajectory points according to the embodiments of the present invention;

FIG. 8 is a schematic diagram illustrating the trajectory according to the compression ratios in the embodiments of the present invention;

FIG. 9 is a schematic diagram illustrating the application of the method for trajectory compression according to the embodiments of the present invention;

FIG. 10 is a schematic diagram illustrating the main structure of the apparatus for trajectory compression according to the embodiments of the present invention;

FIG. 11 is an exemplary system architecture diagram in which the embodiments of the invention can be applied;

FIG. 12 is a schematic diagram illustrating the structure of a computer system of the terminal devices or server suitable for implementing the embodiments ofthe present invention.

### DESCRIPTION OF THE EMBODIMENTS

Explanations about the exemplary embodiments of the present invention will be made below with reference to the drawings, including various details of the embodiments of the present invention so as to help to understand, and the exemplary embodiments should be regarded as merely exemplary. Therefore, a person of ordinary skill in the art should recognize that various changes and modifications can be made to the embodiments described herein without departing from the scope and spirit of the present disclosure. Also, for the sake of clarity and conciseness, descriptions of well-known functions and structures are omitted in the following descriptions.

At present, trajectory compression policies are mainly divided into two types, i.e., lossy compression and lossless compression. By lossy compression, points that contribute less to trajectory information are not recorded on the premise that compression errors are within an acceptable range so as to achieve a compressing purpose, and an original trajectory cannot be restored by a compressed trajectory since some trajectory points are directly missing. Lossless compression generally achieves a worse compression effect than lossy compression and has a relatively low compression ratio, but it can reserve all information of an original trajectory, such that the original trajectory can be completely restored.

The lossy compression method is mainly a Douglas-Puck algorithm, referred to as a DP algorithm for short. The DP algorithm globally considers trajectory information mainly based on the idea of a dynamic programming algorithm, and by setting thresholds, it iteratively screens trajectory points that exceed the thresholds, such that the purpose of trajectory dilution and compression is realized while ensuring the shape of an original trajectory.

The DP algorithm belongs to lossy compression, and it mainly has three disadvantages:

### 1. High Time Complexity

The time complexity of the DP algorithm is O(n²), wherein n is the number of points included in a trajectory. Too high time complexity will increase the time consumption for compression, and thereby will affect user experiences of its upper layer applications, such as trajectory visualization.

### 2. Requirement for Knowledge of the Global Information in Advance

Information of all trajectory points needs to be inputted before running the DP algorithm. On the one hand, in the case of a limited memory, input of a full trajectory with a massive amount of data tends to cause a memory overflow, which makes it impossible to process the trajectory. On the other hand, a trajectory is generated continuously and dynamically, and it is impossible to wait for generation of all trajectory points before processing. This requires that a compression algorithm should have an ability of stream processing, i.e., processing one trajectory point when one trajectory point can be generated. However, the DP algorithm does nothave such ability.

### 3. Unable to Well Reserve Key Trajectory Points Generated During Road Switching

During the design of the DP algorithm, changes in trajectory curvatures of a moving object such a vehicle in the process of road switching on a road network are nottaken into account, such that trajectory points generated at road intersections cannot be well captured, and thereby some key trajectory information is missing.

To sum up, the time complexity is too high when trajectory data is compressed using an existing method, which gives rise to an increase in the time consumption for compression.

To solve the technical problem about too high time complexity, the following technical solutions in the embodiments of the present invention can be adopted.

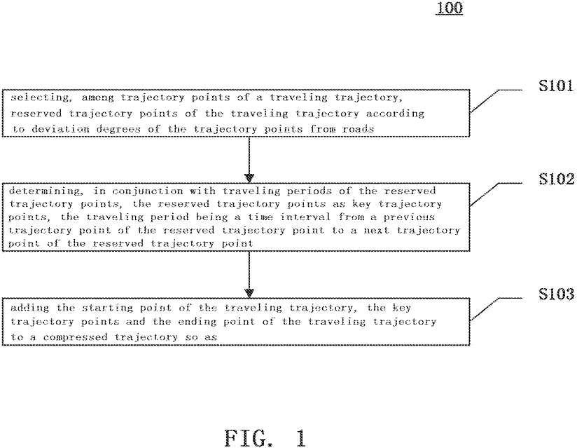

Referring to FIG. 1, which is a flowchart illustrating the main procedures of the method for trajectory compression according to the embodiments of the present invention. The method for trajectory compression realizes compression of a trajectory by screening key trajectory points among trajectory points of a traveling trajectory, and as shown in FIG. 1, specifically comprises the following step:

S101. screening, among trajectory points of a traveling trajectory, reserved trajectory points of the traveling trajectory according to deviation degrees of the trajectory points from roads.

In a road network, vehicles and pedestrians travel on a road. The location where a vehicle/pedestrian is located is referred to as a trajectory point. For a trajectory point p = <Ing; lat; t>, the coordinates of the trajectory point include a longitude Ing, a latitude lat and a timestamp t. The trajectory point indicates that a moving object is at a geographical coordinate location <lng; lat> at time t.

A set of trajectory points of an identical vehicle or an identical pedestrian is referred to as a traveling trajectory. In a traveling trajectory tr=<p₁,p₂, ..., pₙ>, pᵢ=<lngᵢ; latᵢ; tᵢ> is a trajectory point, and for any two points pᵢ and pⱼ, tᵢ> tⱼ if i>j, i.e., trajectory points form a trajectory in a chronological order. The traveling trajectory of a vehicle will be taken below as an example for illustrations.

A single road of a road network in space often assumes a straight line. If a vehicle travels on a certain road, trajectory points of the vehicle mostly assume a straight line without considering location errors. Therefore, it is possible to screen reserved trajectory points of the traveling trajectory based on deviation degrees of the trajectory points from roads. The number of reserved trajectory points is smaller than the number of trajectory points.

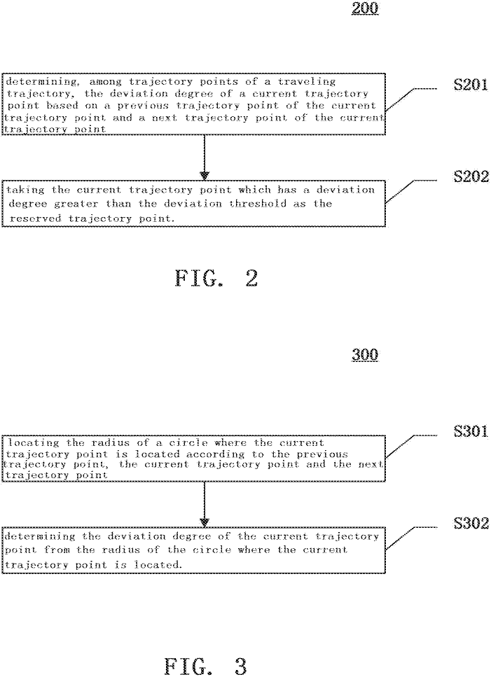

Referring to FIG. 2, which is a flowchart of screening reserved trajectory points of a traveling trajectory according to the embodiments of the present invention, specifically comprising the following step:

S201. determining, among trajectory points of a traveling trajectory, the deviation degree of a current trajectory point based on a previous trajectory point of the current trajectory point and a next trajectory point of the current trajectory point.

A traveling trajectory includes a plurality of trajectory points. A plane where a current trajectory point is located can be determined by a previous trajectory point of the current trajectory point, the current trajectory point, and a next trajectory point of the current trajectory point, and thereby the deviation degree of the current trajectory point from the road can be determined.

Referring to FIG. 3, which is a flowchart of determining the deviation degree of a current trajectory points according to the embodiments of the invention, specifically comprising the following step:

S301. locating the radius of a circle where the current trajectory point is located according to the previous trajectory point, the current trajectory point and the next trajectory point.

A plane can be determined according to a previous trajectory point, a current trajectory point and a next trajectory point. Specifically, the radius of a circle, where a current trajectory point is located, is located according to a previous trajectory point, the current trajectory point and a next trajectory point. If the above circle has a larger radius, the three trajectory points form a straight line; if the above circle has a smaller radius, the above three trajectory points form a circular arc, and the vehicle may switch the traveling road.

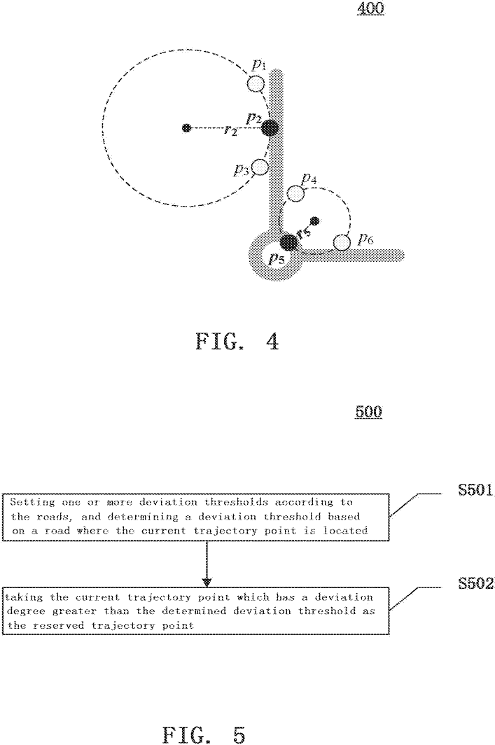

Referring to FIG. 4, which is a schematic diagram of the vehicle traveling according to the embodiments of the present invention. In FIG. 4, the gray lines represent the actual roads, and when the vehicle travels from p₁ to p₃ as indicated by p₁→p₂→p₃, the circle formed by the three trajectory points has a relatively large radius.

If the vehicle enters an intersection and is about to switch the traveling road, its trajectory points will be curved. When the vehicle travels from _{P4} to _{P6} as indicated by p₄→p₅→_{P6} in FIG. 4, the radius of the circle formed by the three trajectory points becomes smaller.

S302. Determining the deviation degree of the current trajectory point from the radius of the circle where the current trajectory point is located.

The smaller the radius of the circle where the current trajectory point is located, the higher the deviation degree of the current trajectory point; the larger the radius of the circle where the current trajectory point is located, the lower the deviation degree of the current trajectory point.

In one embodiment of the present invention, a degree of the deviation of a curved line formed by three trajectory points from the straight line is measured by a space curvature. pᵢ₋₁,pᵢ and pᵢ₊₁ are taken as three consecutive trajectory points, in which r is the radius of a circle determined by the three points, then the space curvature of pi is Kₛ =1/r. In special circumstances, Kₛ is specified as 0 if three trajectory points are collinear.

If the space curvature is greater, the curving degree ofthe curved line will be higher, and more information will be included in a trajectory point, such as the current vehicle is traveling at an intersection and the like. At this time, the trajectory point should be retained.

In the embodiment of FIG. 3, the deviation degree of the current trajectory point is determined by three trajectory points.

S202. Taking the current trajectory pointwhich has a deviation degree greater than the deviation threshold as a reserved trajectory point

A deviation threshold is preset. When the deviation degree ofthe current trajectory point is greater than the deviation threshold, it indicates that the current trajectory point may be a trajectory point of a vehicle traveling at an intersection and the current trajectory point needs to be reserved. Therefore, the current trajectory point which has a deviation degree greater than the deviation threshold is taken as a reserved trajectory point.

Referring to FIG. 5, which is a flowchart of determining reserved trajectory points according to the embodiments of the present invention, specifically comprising the following steps:

S501. Setting one or more deviation thresholds according to roads, and determining a deviation threshold based on a road where the current trajectory point is located.

For roads, they are generally straight lines. In special cases such as mountainous regions, the curving degrees of roads are relatively large. Then, one or more deviation thresholds may be set according to the roads. For example, a deviation threshold is set for roads in the shape of a straight line; and more deviation thresholds are set based on the curving degrees for roads which have relatively high curving degrees. For the current trajectory point, a deviation threshold can be determined according to a road where it is located.

S502. Taking the current trajectory pointwhich has a deviation degree greater than the determined deviation threshold as the reserved trajectory point

When the deviation degree of the current trajectory point is greater than the deviation threshold, it indicates that the vehicle is more likely to turn on the road. Further, the current trajectory point which has a deviation degree greater than the determined deviation threshold can be taken as a reserved trajectory point.

In the embodiment of FIG. 5, more deviation thresholds are set for the roads, which is thereby suitable for compression of a trajectory on roads in various shapes.

S102. Determining, in conjunction with traveling periods of the reserved trajectory points, the reserved trajectory points as key trajectory points, the traveling period being a time interval from a previous trajectory point of the reserved trajectory point to a next trajectory point of the reserved trajectory point

In the process of trajectory compression, a reserved trajectory point which has a relatively high deviation degree may not be generated during road switching, and it may also be a noise point.

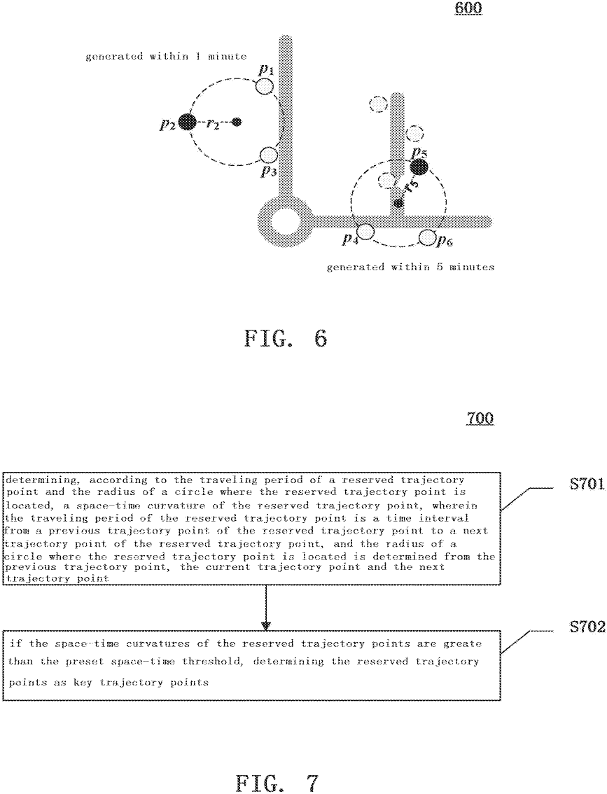

Referring to FIG. 6, which is a schematic diagram illustrating the deviation degrees of a trajectory under a constraint of time according to the embodiments of the present invention. In FIG. 6, as indicated by p₁→p₂→p₃, p₂ has a relatively high deviation degree, but a trajectory point having a high deviation degree should be not generated since the vehicle is traveling on a straight road. The reason for this phenomenon is thatp₂ is a noise point, which deviates far from the original path, thereby resulting in an erroneous judgment.

To identify a noise point correctly, in the embodiments of the present invention, reserved trajectory points is determined as key trajectory points in conjunction with traveling durations of the reserved trajectory points. The traveling period is a time interval from a previous trajectory point of a reserved trajectory point to a next trajectory point of a reserved trajectory point.

In other words, when a time range (i.e., a traveling duration) is relatively small, it indicates that the three trajectory points are generated in a short period of time, so the three trajectory points should be on an identical straight line. If a noise point generated at this time causes trajectory deviation, a small time range can also minimize the deviation degree, such that the trajectory point is discarded, such as _{P2} in FIG. 6.

On the contrary, when the traveling period is relatively long, it indicates that a time difference generated by the three trajectory points is relatively large. Then, even if deviation occurs, it can be regarded that the vehicle has traveled to other roads during this period of time, and it is only a case that trajectory points on other roads are not collected because of alow sampling rate ofthe device. Atthis time, the deviation degree is relatively high, and finally the trajectory point is reserved, such as _{P2} in FIG. 6.

Referring to FIG. 7, which is a flowchart of determining key trajectory points according to the embodiments of the present invention, specifically comprising the following steps:

S701. determining, according to the traveling period of a reserved trajectory point and the radius of a circle where the reserved trajectory point is located, a space-time curvature of the reserved trajectory point, wherein the traveling period of the reserved trajectory point is a time interval from a previous trajectory point of the reserved trajectory point to a next trajectory point of the reserved trajectory point, and the radius of a circle where the reserved trajectory point is located is determined from the previous trajectory point, the current trajectory point and the next trajectory point.

In the embodiments ofthe present invention, itis necessary to determine the space-time curvatures ofthe reserved trajectory points in orderto obtain key trajectory points. Specifically, the space-time curvature of a reserved trajectory point is determined according to a traveling period of the reserved trajectory point and the radius of a circle where the reserved trajectory point is located.

The traveling period of the reserved trajectory point is a time interval from a previous trajectory point of the reserved trajectory point to a next trajectory point of the reserved trajectory point, and the radius of a circle where the reserved trajectory point is located is determined from the previous trajectory point, the current trajectory points and the next trajectory point.

As an example, the space-time curvature of a reserved trajectory point is equal to a ratio of the traveling period of the reserved trajectory point to the radius of a circle where the reserved trajectory point is located. pᵢ₋₁, pᵢ and pᵢ₊₁ are taken as three consecutive trajectory points, in which Kᵢ is the space-time curvature of pᵢ, then the space-time curvature of pᵢ is defined as Kₛₜ =Kₛ*Δt=Δt/r°, wherein Δt=tᵢ₊₁- tᵢ.₁.

A space-time curvature measures the deviation degree of a curved line formed by three points under a constraint of time. Here, the constraint of time is a time range Δt generated by the three points. In the condition of the same space curvature, the larger the time range is, the higher the space-time curvature is. At this time, the trajectory point should be reserved.

S702. If the space-time curvature of the reserved trajectory point is greater than the preset space-time threshold, determining the reserved trajectory point as a key trajectory points

In the embodiments of the present invention, key trajectory points are determined by the preset space-time threshold. The preset space-time threshold can be set based on an actual application scenarios and experiences. Specifically, if the space-time curvature ofthe reserved trajectory pointis greater than the preset space-time threshold, the reserved trajectory point is determined as a key trajectory point.

In the embodiment of FIG. 7, the space-time curvature has a certain ability to resist noise interferences while keeping an advantage of the space curvature of being able to identify a key trajectory point at a corner. The purpose of trajectory compression is to reserve points having relatively large space-time curvatures as much as possible and discard points having relatively small space-time curvatures.

In one embodiment of the present invention, it is taken into account that not only key trajectory points can be determined but also reserved trajectory points can be screened in consideration of space-time curvatures.

Specifically, among trajectory points of a traveling trajectory, trajectory points which have deviation degrees greater than the deviation threshold are screened as reserved trajectory points, wherein the deviation degree is determined by the traveling period of a trajectory point and the radius of a circle where the trajectory point is located. That is to say, a ratio of the traveling period of the trajectory point to the radius of the circle where the trajectory point is located is taken as a deviation degree.

Then, the reserved trajectory points which have ratios greater than the key threshold are taken as key trajectory points. The above ratio is equal to a quotient of dividing the traveling time of a reserved trajectory point by the radius of a circle where the reserved trajectory point is located.

As an example, in the case where the deviation threshold is smaller than the key threshold, reserved trajectory points are screened firstly using the deviation threshold and then key trajectory points are determined among the reserved trajectory points using the key threshold. As another example, in the case where the deviation threshold is equal to the key threshold, key trajectory points can be determined among the trajectory points through one-time comparison.

S103. Adding the starting point, the key trajectory points and the ending point of the traveling trajectory to a compressed trajectory to compress the traveling trajectory

A trajectory is generated on a road network, and it is trajectory points generated by a vehicle continuously traveling on different roads. When a vehicle travels from one road to another, a certain deviation angle will be inevitably generated, such that a point at a junction of roads will be curved. The purpose of trajectory compression is to eliminate invalid points in the trajectory and reserve its key trajectory points as much as possible.

For trajectory points generated on an identical straight road, they are all invalid points except the starting and ending points, because they do not generate any information and it can be inferred only from the starting and ending points that the vehicle is traveling on the road. On the contrary, the starting and ending points which are generated at junctions of different roads are key trajectory points. The purpose of trajectory compression is to reserve key trajectory points as much as possible and discard invalid points. Further, the starting point of the traveling trajectory, the key trajectory points and ending point of the traveling trajectory are added to a compressed trajectory so as to compress the traveling trajectory.

In one embodiment of the present invention, the deviation threshold and the key threshold are determined by the number of trajectory points in a compressed trajectory and the number of trajectory points in a traveling trajectory. As an example, a compression ratio = the number of original trajectory points/the number of compressed trajectory points. The larger the compression ratio is, the greater the deviation threshold and the key threshold are. A deep learning model can be used to obtain the specific functional relationship of a deviation threshold and a key threshold with a compression ratio.

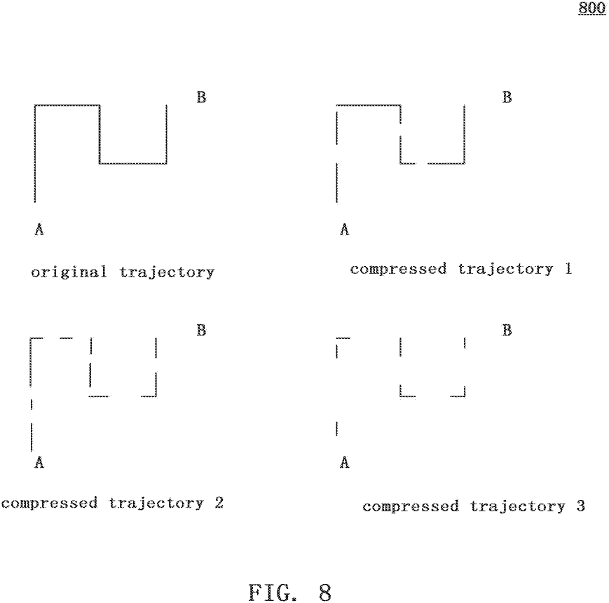

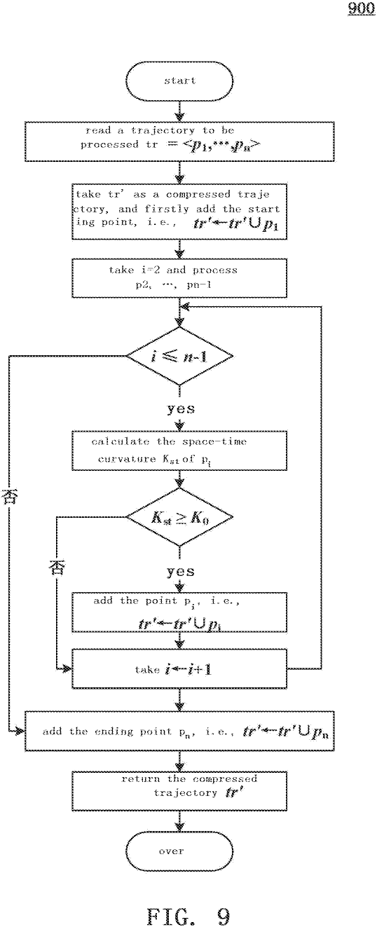

Referring to FIG. 8, which is a schematic diagram illustrating the trajectory according to the compression ratios in the embodiments of the present invention. The upper left figure of FIG. 8 shows an original trajectory from place A to place B; the upper right figure of FIG. 8 shows a compressed trajectory 1 in which the deviation threshold and the key threshold are determined by the first compression ratio; the lower left figure of FIG. 8 shows a compressed trajectory 2 in which the deviation threshold and the key threshold are determined by the second compression ratio; the lower right right of FIG. 8 shows a compressed trajectory 3 in which the deviation threshold and the key threshold are determined by the third compression ratio, wherein the first compression ratio < the second compression ratio < the third compression ratio. As can be seen, the number of key trajectory points decreases as the compression ratio increases.

It can be seen from FIG. 8 that the deviation threshold and key threshold increase gradually as the compression ratio gradually increases. As a result of an increase in the deviation threshold and key threshold, the conditions for being referred to as key trajectory points are more stringent, such that trajectory points at intersections tend to be reserved so as to achieve a better compression effect while reserving key traveling information of the whole trajectory.

Referring to FIG. 9, which is a flowchart illustrating the application of the method for trajectory compression according to the embodiments of the present invention, specifically comprising the following steps:

When both the deviation threshold and the key threshold are equal to K₀, the space-time curvature Kₛₜ of each trajectory point is calculated sequentially, and if K₀, the trajectory point is taken as a key trajectory point, otherwise the trajectory point is discarded. For the starting point and the ending point of a traveling trajectory, the space-time curvatures cannot be calculated, and for this reason, the starting point and the ending point of the traveling trajectory can be directly reserved.

Firstly, K₀ is preset to make a compressed trajectory tr′ as an empty set, and the starting point is added. A trajectory to be processed tr = <p₁,...,pₙ> is read, the space-time curvatures Kₛₜ of all trajectory points except the starting point and the ending point are calculated sequentially, and if Kₛₜ ≥ K₀, the trajectory points are reserved, and otherwise are discarded. Finally, the ending point is added to the compressed trajectory, the result is returned and the compression task is ended.

The following technical solutions in the above embodiments of the present invention are adopted: screening, among trajectory points of a traveling trajectory, reserved trajectory points of the traveling trajectory according to deviation degrees of the trajectory points from roads; determining, in conjunction with traveling periods of the reserved trajectory points, the reserved trajectory points as key trajectory points; adding the starting point of the traveling trajectory, the key trajectory points and the ending point of the traveling trajectory to a compressed trajectory so as to compress the traveling trajectory. Since the number of key trajectory points is far less than the number of trajectory points, it is possible to reduce the time complexity of compression of trajectory data, and thereby decrease the time consumption for compression.

In the embodiments of the present invention, only three trajectory points are required for judgment of a trajectory point, i.e., a previous trajectory point ofthe current trajectory point, the current trajectory point and a next trajectory point of the current trajectory point. This is a constant, which can be ignored when calculating the time complexity. In other words, the time complexity is O(n). Compared with the traditional DP algorithm, the time consumption is greatly reduced and the user experience is effectively improved.

In addition, during judgment of whether a trajectory point should be reserved, only local information is required. That is, the judgment only involves information of three trajectory points, requiring no participation of global information. In such way, it is not necessary to load the full trajectory into the memory to participate in the calculation. In the context of Big Data, the demand for memory resources is greatly reduced, making it capable of processing a massive amount of trajectory data.

Finally, while a trajectory pointis dynamically generated, the judgment of whether to reserve the trajectory point is also ongoing, which also benefits from the feature that it does not require global information to participate in the calculation, such that richer upper applications can be developed, for example, real-time trajectory dilution, compression and visualization.

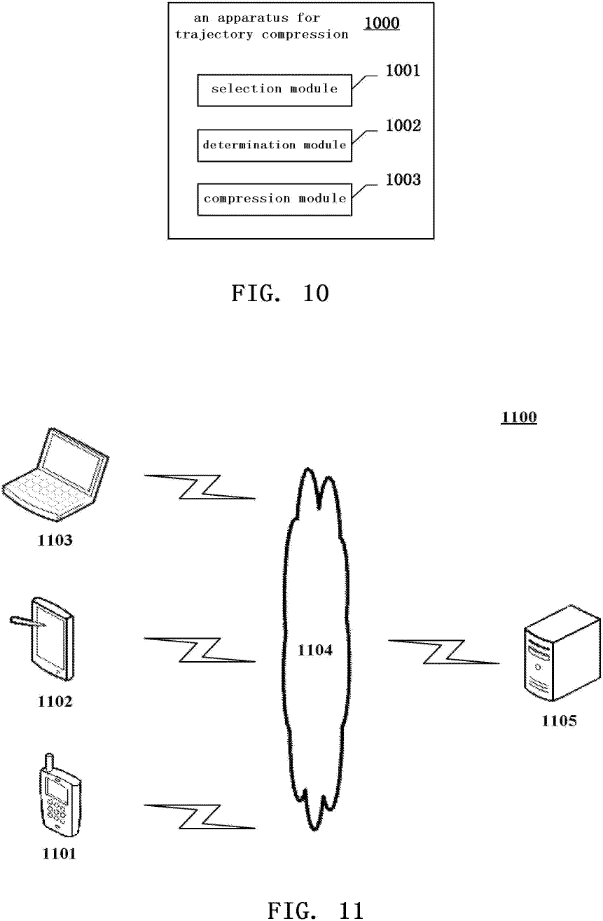

Referring to FIG. 10, which is a schematic diagram illustrating the main structure ofthe apparatus for trajectory compression according to the embodiments ofthe present invention. The apparatus for trajectory compression can implement the method for trajectory compression, and as shown in FIG. 10, the apparatus for trajectory compression specifically comprises:
a screening module 1001 for screening, among trajectory points of a traveling trajectory, reserved trajectory points of the traveling trajectory according to deviation degrees of the trajectory points from roads;
a determination module 1002 for determining, in conjunction with traveling periods of the reserved trajectory points, the reserved trajectory points as key trajectory points, the traveling period being a time interval from a previous trajectory point of the reserved trajectory point to a next trajectory point of the reserved trajectory point;
a compression module 1003 for adding the starting point ofthe traveling trajectory, the key trajectory points and the ending point of the traveling trajectory to a compressed trajectory so as to compress the traveling trajectory.

In one embodiment of the invention, the screening module 1001 is specifically used for determining, among trajectory points of a traveling trajectory, the deviation degree of a current trajectory point based on a previous trajectory point of the current trajectory point and a next trajectory point of the current trajectory point;

taking the current trajectory point which has a deviation degree greater than the deviation threshold as the reserved trajectory point.

In one embodiment of the invention, the screening module 1001 is specifically used for locating the radius of a circle where the current trajectory point is located according to the previous trajectory point, the current trajectory point and the next trajectory point;

determining the deviation degree of the current trajectory point from the radius of the circle where the current trajectory point is located.

In one embodiment of the present invention, the screening module 1001 is specifically used for setting one or more deviation thresholds according to the roads, and determining a deviation threshold based on a road where the current trajectory point is located;

taking the current trajectory point which has a deviation degree greater than the determined deviation threshold as the reserved trajectory point.

In one embodiment of the present invention, the determination module 1002 is specifically used for determining, according to the traveling period of a reserved trajectory point and the radius of a circle where the reserved trajectory point is located, a space-time curvature of the reserved trajectory point, wherein the traveling period of the reserved trajectory point is a time interval from a previous trajectory point of the reserved trajectory point to a next trajectory point of the reserved trajectory point, and the radius of a circle where the reserved trajectory point is located is determined from the previous trajectory point, the current trajectory point and the next trajectory point;

if the space-time curvature ofthe reserved trajectory pointis greater than the preset space-time threshold, determining the reserved trajectory point as a key trajectory point.

In one embodiment of the present invention, the screening module 1001 is specifically used for screening, among trajectory points of a traveling trajectory, a trajectory point which has a deviation degree greater than the deviation threshold as a reserved trajectory point, wherein the deviation degree is determined by a traveling period of the trajectory point and the radius of a circle where the trajectory point is located;

the determination module 1002 is specifically used for taking reserved trajectory points which have ratios greater than the key threshold as key trajectory points, the ratio being equal to a quotient of dividing the traveling period of a reserved trajectory point by the radius of a circle where the reserved trajectory point is located.

In one embodiment of the present invention, the deviation threshold and the key threshold are determined by the number of trajectory points in the compressed trajectory and the number of trajectory points in the traveling trajectory.

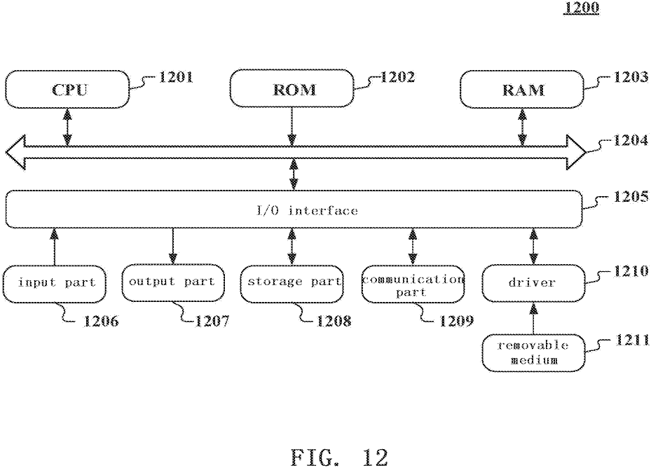

FIG. 11 shows an exemplary system architecture 1100 in which the method for trajectory compression or the apparatus for trajectory compression according to the embodiments of the present invention can be applied.

As shown in FIG. 11, the system architecture 1100 may comprise terminal devices 1101, 1102, 1103, a network 1104, and a server 1105. The network 1104 is used for providing media for communication links between the terminal devices 1101, 1102, 1103 and the server 1105. The network 1104 may include various connection types, such as wired links, wireless communication links, fiber-optic cables and the like.

A user can use the terminal devices 1101, 1102, 1103 to interact with the server 1105 through the network 1104, so as to receive or send a message or the like. On the terminal devices 1101, 1102, 1103, various communication client applications can be installed, such as shopping applications, web browser applications, search applications, instant messaging tools, email clients, social platform software and so on (which are only exemplary).

The terminal devices 1101, 1102, 1103 may be various electronic devices with a display screen and supporting web browsing, including but not limited to smart phones, tablet computers, laptop-type portable computers, desktop computers, and so on.

The server 405 may be a server which provides various services, such as a backend management server (which is only exemplary) which provides support for shopping websites browsed by users via the terminal devices 1101, 1102, 1103. The backend management server can process, such as analyze, the received product information query request and other data, and feedback the processing results (such as target push information, product information - only exemplary) to the terminal devices.

It should be noted that: the method for trajectory compression provided in the embodiments of the present invention is generally performed by the server 1105. Accordingly, the apparatus for trajectory compression is generally disposed in the server 1105.

It should be understood that the number of the terminal devices, the network and the server is only illustrative in FIG. 11. The system architecture may comprise any number of terminal devices, networks and servers according to the implementation requirements.

Hereinafter, referring to FIG. 12, which is a schematic diagram illustrating the structure of a computer system 1200 of the terminal devices or server suitable for implementing the embodiments of the present invention. The terminal devices shown in FIG. 12 are only exemplary, and should not construe any limitations of the function and scope of use of the embodiments of the present invention.

As shown in FIG. 12, the computer system 1200 comprises a central processing unit (CPU) 201, which can perform various appropriate actions and processing according to a program stored in a read only memory (ROM) 1202 or a program loaded from a storage part 1208 to a random access memory (RAM) 1203. In the RAM 503, various programs and data required for operations of the system 1200 are also stored. The CPU 1201, ROM 1202, and RAM 1203 are connected to one another through a bus 1204. An input/output (I/O) interface 1205 is also connected to the bus 1204.

The following components are connected to the I/O interface 1205: an input part 1206 including a keyboard, a mouse, etc.; an output part 1207 including a cathode ray tube (CRT), a liquid crystal display (LCD), a speaker, etc.; a storage part 1208 including a hard disk, etc.; and a communication part 1209 including a network interface card such as a LAN card, a modem, etc. The communication part 1209 performs communication processing via a network such as the Internet. A driver 1210 is also connected to the I/O interface 1205 as needed. A removable medium 1211, such as a magnetic disk, an optical disk, a magneto-optical disk, a semiconductor memory or the like, is installed on the driver 1210 as needed, such that computer programs read from the driver 510 can be installed in the storage part 1208 as needed.

In particular, according to the embodiments of the present invention, the above process described with reference to the flowcharts can be implemented as a computer software program. For example, the embodiments of the present invention comprise a computer program product, which includes a computer program carried on a computer-readable medium, the computer program including a program code for executing the method as shown in the flowcharts. In such embodiments, the computer program may be downloaded and installed from the network through the communication part 1209, and/or installed from the removable medium 1211. When the computer program is executed by the central processing unit (CPU) 1201, the above functions defined in the system of the present invention are performed.

It should be noted that: the computer-readable medium in the present invention may be a computer-readable signal medium or a computer-readable storage medium or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but not limited to, an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present invention, a computer-readable storage medium may be any tangible medium that contains or stores a program, which may be used by or in combination with an instruction execution system, apparatus, or device. In the present invention, a computer-readable signal medium may include a data signal propagated in a baseband or as a part of a carrier, in which a computer-readable program code is carried. The data signal which is propagated in this way may be in various forms, including but not limited to an electromagnetic signal, an optical signal, or any suitable combination thereof. The computer-readable signal medium may also be any computer-readable medium other than the computer-readable storage medium. The computer-readable medium may send, propagate, or transmit a program for use by or in combination with an instruction execution system, apparatus or device. The program code contained on the computer-readable medium can be transmitted by any suitable medium, including but not limited to: wireless medium, wire, optical cable, RF, etc., or any suitable combination thereof.

The flowcharts and block diagrams in the drawings illustrate the system architecture, functions, and operations, which may be implemented, of the system, method, and computer program product according to various embodiments of the present disclosure. In this regard, each block in the flowcharts or block diagrams may represent a module, a program segment, or a part of the code, which includes one or more executable instructions for realizing the specified logic functions. It should also be noted that: in some alternative implementations, the functions marked in the blocks may also occur in a different order from the order marked in the drawings. For example, two blocks shown successively can be actually executed in parallel substantially, and they can sometimes be executed in a reverse order, depending on the functions involved. It should also be noted that: each block in the block diagrams or flowcharts and a combination of blocks in the block diagrams or flowcharts can be implemented by a dedicated hardware-based system that performs specified functions or operations, or can be implemented by a combination of dedicated hardware and computer instructions.

The involved modules described in the embodiments of the present disclosure can be implemented in software or hardware. The described modules may also be provided in a processor which is, for example, described as a processor comprising a screening module, a determination module, and a compression module, wherein the names of these modules do not construe limitations of the modules themselves in a certain circumstance. For example, the screening module can also be described as “a screening module for screening, among trajectory points of a traveling trajectory, reserved trajectory points of the traveling trajectory according to deviation degrees of the trajectory points from roads”.

As another aspect, the present invention also provides a computer-readable medium, which may be included in the device described in the above embodiments or may exist alone without being assembled into the device. The above computer-readable medium carries one or more programs which, when executed by a device, causes the device to perform operations including:
screening, among trajectory points of a traveling trajectory, reserved trajectory points of the traveling trajectory according to deviation degrees of the trajectory points from roads;
determining, in conjunction with traveling periods ofthe reserved trajectory points, the reserved trajectory points as key trajectory points, the traveling period being a time interval from a previous trajectory point of the reserved trajectory point to a next trajectory point of the reserved trajectory point;
adding the starting point of the traveling trajectory, the key trajectory points and the ending point of the traveling trajectory to a compressed trajectory so as to compress the traveling trajectory.

According to the technical solutions of the embodiments of the present invention, among trajectory points of a traveling trajectory, reserved trajectory points of the traveling trajectory are screened according to deviation degrees of the trajectory points from roads; in conjunction with traveling periods of the reserved trajectory points, the reserved trajectory points are determined as key trajectory points, the traveling period being a time interval from a previous trajectory point of the reserved trajectory point to a next trajectory point of the reserved trajectory point; the starting point of the traveling trajectory, the key trajectory points and the ending point of the traveling trajectory are added to a compressed trajectory so as to compress the traveling trajectory. Since the number of key trajectory points is far smaller than the number of trajectory points, it is possible to reduce the time complexity of compression of trajectory data, and thereby decrease the time consumption for compression.

The above embodiments do not construe limitations of the protection scope of the present invention. Those skilled in the art should understand that various modifications, combinations, sub-combinations and substitutions may occur depending on the design requirements and other factors. Any modifications, equivalent substitutions and improvements, and the like within the spirit and principle of the present disclosure should be contained in the scope of protection of the present disclosure.

1. A method for trajectory compression, comprising:
screening, among trajectory points of a traveling trajectory, reserved trajectory points of the traveling trajectory according to deviation degrees of the trajectory points from roads;
determining, in conjunction with traveling periods of the reserved trajectory points, the reserved trajectory points as key trajectory points, the traveling period being a time interval from a previous trajectory point of the reserved trajectory point to a next trajectory point of the reserved trajectory point; and
adding the starting point of the traveling trajectory, the key trajectory points and the ending point of the traveling trajectory to a compressed trajectory so as to compress the traveling trajectory.

2. The method for trajectory compression according to claim 1, wherein:
screening, among trajectory points of a traveling trajectory, reserved trajectory points of the traveling trajectory according to deviation degrees of the trajectory points from roads includes:
determining, among trajectory points of a traveling trajectory, the deviation degree of a current trajectory point based on a previous trajectory point of the current trajectory point and a next trajectory point of the current trajectory point; and
taking the current trajectory point which has a deviation degree greater than the deviation threshold as the reserved trajectory point.

3. The method for trajectory compression according to claim 2, wherein:
determining the deviation degree of a current trajectory point based on a previous trajectory point of the current trajectory point and a next trajectory point of the current trajectory point includes:
locating the radius of a circle where the current trajectory point is located according to the previous trajectory point, the current trajectory point and the next trajectory point; and
determining the deviation degree of the current trajectory point from the radius of the circle where the current trajectory point is located.

4. The method for trajectory compression according to claim 2, wherein:
taking the current trajectory point which has a deviation degree greater than the deviation threshold as the reserved trajectory point includes:
setting one or more deviation thresholds according to the roads, and determining a deviation threshold based on a road where the current trajectory point is located; and
taking the current trajectory point which has a deviation degree greater than the determined deviation threshold as the reserved trajectory point.

5. The method for trajectory compression according to claim 1, wherein:
determining, in conjunction with traveling periods of the reserved trajectory points, the reserved trajectory points as key trajectory points includes:
determining, according to the traveling period of a reserved trajectory point and the radius of a circle where the reserved trajectory point is located, a space-time curvature of the reserved trajectory point, wherein the traveling period of the reserved trajectory point is a time interval from a previous trajectory point of the reserved trajectory point to a next trajectory point of the reserved trajectory point, and the radius of a circle where the reserved trajectory point is located is determined from the previous trajectory point, the current trajectory point and the next trajectory point; and
if the space-time curvatures of the reserved trajectory points are greater than the preset space-time threshold, determining the reserved trajectory points as key trajectory points.

6. The method for trajectory compression according to claim 1, wherein:
screening, among trajectory points of a traveling trajectory, reserved trajectory points of the traveling trajectory according to deviation degrees of the trajectory points from roads includes:
screening, among trajectory points of a traveling trajectory, a trajectory point which has a deviation degree greater than the deviation threshold as a reserved trajectory point, wherein the deviation degree is determined by a traveling period of the trajectory point and the radius of a circle where the trajectory point is located; and
determining, in conjunction with traveling periods of the reserved trajectory points, the reserved trajectory points as key trajectory points, the determining including:
taking reserved trajectory points which have ratios greater than the key threshold as key trajectory points, the ratio being equal to a quotient of dividing the traveling period of a reserved trajectory point by the radius of a circle where the reserved trajectory point is located.

7. The method for trajectory compression according to claim 6, wherein:
the deviation threshold and the key threshold are determined by the number of trajectory points in the compressed trajectory and the number of trajectory points in the traveling trajectory.

8. (canceled)

9. (canceled)

10. A computer-readable medium storing computer programs thereon, characterized in that the programs, when executed by a processor, implements the method according to claim 1.

11. An electronic device for trajectory compression, comprising:
one or more processors;
a storage device for storing one or more programs which, when executed by the one or more programs, cause the one or more processors to implement a method for trajectory compression, the method for trajectory compression comprising:
screening, among trajectory points of a traveling trajectory, reserved trajectory points of the traveling trajectory according to deviation degrees of the trajectory points from roads;
determining, in conjunction with traveling periods of the reserved trajectory points, the reserved trajectory points as key trajectory points, the traveling period being a time interval from a previous trajectory point of the reserved trajectory point to a next trajectory point of the reserved trajectory point; and
adding the starting point of the traveling trajectory, the key trajectory points and the ending point of the traveling trajectory to a compressed trajectory so as to compress the traveling trajectory.

12. The electronic device according to claim 11, wherein:
screening, among trajectory points of a traveling trajectory, reserved trajectory points of the traveling trajectory according to deviation degrees of the trajectory points from roads includes:
determining, among trajectory points of a traveling trajectory, the deviation degree of a current trajectory point based on a previous trajectory point of the current trajectory point and a next trajectory point of the current trajectory point; and
taking the current trajectory point which has a deviation degree greater than the deviation threshold as the reserved trajectory point.

13. The electronic device according to claim 12, wherein:
determining the deviation degree of a current trajectory point based on a previous trajectory point of the current trajectory point and a next trajectory point of the current trajectory point includes:
locating the radius of a circle where the current trajectory point is located according to the previous trajectory point, the current trajectory point and the next trajectory point; and
determining the deviation degree of the current trajectory point from the radius of the circle where the current trajectory point is located.

14. The electronic device according to claim 12, wherein:
taking the current trajectory point which has a deviation degree greater than the deviation threshold as the reserved trajectory point includes:
setting one or more deviation thresholds according to the roads, and determining a deviation threshold based on a road where the current trajectory point is located; and
taking the current trajectory point which has a deviation degree greater than the determined deviation threshold as the reserved trajectory point.

15. The electronic device according to claim 11, wherein:
determining, in conjunction with traveling periods of the reserved trajectory points, the reserved trajectory points as key trajectory points includes:
determining, according to the traveling period of a reserved trajectory point and the radius of a circle where the reserved trajectory point is located, a space-time curvature of the reserved trajectory point, wherein the traveling period of the reserved trajectory point is a time interval from a previous trajectory point of the reserved trajectory point to a next trajectory point of the reserved trajectory point, and the radius of a circle where the reserved trajectory point is located is determined from the previous trajectory point, the current trajectory point and the next trajectory point; and
if the space-time curvatures of the reserved trajectory points are greater than the preset space-time threshold, determining the reserved trajectory points as key trajectory points.

16. The electronic device according to claim 11, wherein:
screening, among trajectory points of a traveling trajectory, reserved trajectory points of the traveling trajectory according to deviation degrees of the trajectory points from roads includes:
screening, among trajectory points of a traveling trajectory, a trajectory point which has a deviation degree greater than the deviation threshold as a reserved trajectory point, wherein the deviation degree is determined by a traveling period of the trajectory point and the radius of a circle where the trajectory point is located; and
determining, in conjunction with traveling periods of the reserved trajectory points, the reserved trajectory points as key trajectory points, wherein the determining includes:
taking reserved trajectory points which have ratios greater than the key threshold as key trajectory points, the ratio being equal to a quotient of dividing the traveling period of a reserved trajectory point by the radius of a circle where the reserved trajectory point is located.

17. The electronic device according to claim 16, wherein:
the deviation threshold and the key threshold are determined by the number of trajectory points in the compressed trajectory and the number of trajectory points in the traveling trajectory.
